(19) United States
(12) Patent Application Publication
(10) Pub. No.: US 2009/0045059 A1
(43) Pub. Date: Feb. 19, 2009

(54) Method and apparatus for measuring membrane potential of red blood cells using electrophoretic analysis

(76) Inventors: Osamu Nozaki, Osakasayama-shi (JP); Hiroko Kawamoto, Yonago-shi (JP); Motonori Munesue, Matsubara-shi (JP)

Correspondence Address: FLYNN THIEL BOUTELL & TANIS, P.C., 2026 RAMBLING ROAD, KALAMAZOO, MI, 49008-1631, US

(21) Appl. No.: 12/218,320

(22) Filed: Jul. 14, 2008

(30) Foreign Application Priority Data
Aug. 17, 2007 (JP) JP2007-213177

(51) Int. Cl. G01N 27/447; B01D 57/02

(52) U.S. Cl. 204/452; 204/603

(57) ABSTRACT

The present invention provides a method and apparatus for measuring the membrane potential of red blood cells using electrophoretic analysis that analyzes red blood cells whose membrane potentials are reversed due to red blood cell agglutination.

The method includes: dipping an electrophoresis cell into an electrophoresis tank that contains an electrophoresis solution such that a current can flow at the middle of the electrophoresis tank; introducing a specimen for measuring red blood cells to a zero point S (base point) at the center of the electrophoresis cell; capturing the image of the electrophoresis tank with time; performing RGB (red, green, and blue) analysis on image data of each of the captured images; measuring the moving coordinates of the brightness of each B component from the base point for each pixel, thereby analyzing the images; and measuring variation in the electrophoresis direction indicated by the accumulation result of the moving coordinates of the analysis data toward a cathode and an anode. The apparatus includes: an electrophoresis device A that includes an electrophoresis tank 1a having three tanks 101a, 10a, and 101a and an electrophoresis cell 3a dipped into the central tank 10a; an image capturing device 6a that captures the image of the electrophoresis cell 3a with time; and an analyzing device 7a that analyzes image data of the captured image. The electrophoresis solution 2a is contained in the three tanks such that it can flow through the three tanks, and a current can flow through the electrophoresis solution 2a.

### BACKGROUND OF THE INVENTION

1. Field of the Invention

The present invention relates to a method and apparatus for measuring the membrane potential of red blood cells using electrophoretic analysis that is capable of predicting red blood cell agglutination caused by the potential reversal of a blood corpuscle membrane in human blood.

2. Description of the Related Art

Various diseases, such as apoplexy, myocardial infarction, renal insufficiency, cerebral hemorrhage of the eye, and gangrene, are caused by vascular disorders. In particular, vascular disorders are the main cause of death of diabetic patients. Therefore, predicting vascular disorders is very important in preventing vascular complications.

The reasons why vascular complications occur are due to red blood cell agglutination and vascular occlusion caused by red blood cell agglutination on the blood vessel wall. Accordingly, a method and apparatus for analyzing the state of a red blood cell membrane in order to predict the occurrence of the vascular disorders has been proposed. For example, as shown in FIG. 19, a method and apparatus for measuring the distribution of the degree of saccharification of the red blood cell membrane has been proposed.

That is, in the method and apparatus for measuring the distribution of the degree of saccharification of the red blood cell membrane, in an electrophoresis cell in which a cathode inserting hole Hc and an anode inserting hole Ha are formed at a predetermined interval in an upper surface of a transparent rectangular parallelepiped container 1, a specimen injecting hole Hs is formed in the middle between the cathode and anode inserting holes Hc and Ha, and air bubble outlets Hb are provided at predetermined positions on the upper surface of the transparent rectangular parallelepiped container 1, a saline solution is poured into the transparent rectangular parallelepiped container 1, and a cathode line Lc and an anode line La connected to a DC power supply are respectively inserted into the cathode and anode inserting holes Hc and Ha so as to be dipped into the saline solution. Then, a magnetic sheet S is placed on the bottom of the transparent rectangular parallelepiped container 1, and a red blood cell specimen coupled to a boric acid group introducing magnetic bead is injected into the container through the specimen injecting hold Hs.

According to the principle of the above, when the red blood cell membrane is saccharified, the number of diols in a sugar molecule increases. However, the diols in the sugar molecule is coupled to the boric acid group of the boric acid group introducing the magnetic bead in alkali pH. As a result, the magnetic bead is coupled to the red blood cell membrane with the boron interposed therebetween.

The red blood cell coupled to the magnetic bead is strongly affected by an external magnetic field in proportion to the number of magnetic beads, and the electrophoresis thereof is suppressed. The degree of suppression of electrophoresis indicates the degree of saccharification of the red blood cells.

A specimen for measuring glycohemoglobin A1c (HbA1c) (high-performance liquid chromatography, a normal range is from 4.3 to 5.8%) is used as the red blood cell specimen, and a material obtained by glutaraldehyde coupling between an amino group introducing magnetic bead and boric acid is used as the boric acid group introducing magnetic bead.

The boric acid magnetic bead is coupled to the red blood cell as follows. A saline solution having a volume that is ten times larger than that of the blood specimen is added and centrifuged, and a supernatant material is removed to produce cleaned red blood cells. Then, a tricine buffer solution is added to the cleaned red blood cells, and the boric acid magnetic beads are added to react with the red blood cells.

Then, the red blood cell specimen generated in this way is injected into the electrophoresis cell (electrophoresis solution is a saline solution, pH 7.4) through the specimen injecting hole Hs, and a voltage (4 to 5 V and 20 mA) is applied. Then, a digital camera for capturing an electrophoresis image is used to capture the image of the electrophoresis cell from the upper surface, and the degree of saccharification of the red blood cell membrane is analyzed by a computer on the basis of captured image data.

[Patent Document 1] JP-A-2005-49156 (page No. 6 and FIG. 2)

However, for the potentials of the membrane of a red blood cell and the inside of the red blood cell, when the potential of the membrane of a red blood cell is negative and the potential of the inside thereof is positive, the red blood cell is considered to be normal, and the normal red blood cells are repulsed and it is difficult to agglutinate the normal red blood cells. However, when the potential of the membrane of the red blood cell is lowered due to factors such as an increase in age or an interaction with blood plasma components or when the potential of the membrane of the red blood cell and the potential of the inside thereof are changed to a positive level, the red blood cell is coupled to a normal red blood cell having a negative membrane potential, and it is easy to agglutinate the red blood cells, which is the main cause of vascular disorders, such as thrombus.

A technique has already been proposed for checking red blood cells having a reversed membrane potential, which is the cause of a disease, on the basis of the distribution of the red blood cells in the electrophoresis direction. It is considered that the membrane potential of some of the red blood cells is reversed during electrophoresis due to the life span or an interaction with vascular components, which causes a variation in the electrophoresis direction of the red blood cells.

It is supposed that the red blood cells whose electrophoresis direction varies during electrophoresis may, which causes vascular disorders or diseases, be agglutinated. However, the related art does not disclose means capable of predicting red blood cell agglutination due to the variation in the membrane potential of the red blood cells.

Further, measuring the viscosity of the whole blood in order to prevent thrombosis has been considered. However, in the related art, there has not been means proposed that is capable of measuring the viscosity of whole blood in the electrophoretic analysis field.

Furthermore, in the above-mentioned electrophoretic analysis apparatus capable of predicting vascular disorders according to the related art, a rectangular parallelepiped container with a flat bottom surface is used as the electrophoresis cell. However, when specimens are distributed on the bottom of the container in the direction (horizontal direction) in which the cathode and anode lines extend, the specimens are distributed in the vertical direction (forward and backward direction), which is not necessarily needed during analysis, in addition to the horizontal direction, resulting in unnecessary analysis of the distribution of the specimens in the direction in which the cathode and anode lines extend.

In addition, the cathode and anode lines are provided inside the electrophoresis tank to which the specimens are introduced. Therefore, when a voltage is applied, electrolytic bubbles are generated, which makes it difficult to capture a high-resolution and uniform electrophoresis image of the electrophoresis cell from the upper side.

Further, a Good's buffer, which has been widely used in biochemistry, such as cell culture or tissue culture, has been commonly used as the electrophoretic analysis. However, no electrophoresis solution that is capable of accurately measuring the membrane potential of red blood cells has been developed.

### SUMMARY OF THE INVENTION

Accordingly, the invention has been made in order to solve the above problems, and an object of the invention is to provide a method and apparatus for measuring the membrane potential of red blood cells electrophoresis using electrophoretic analysis that is capable of predicting red blood cell agglutination on the basis of the content of red blood cells whose electrophoresis direction is reversed during electrophoresis, solving the problem of the unnecessary analysis based on the distribution of specimens in the direction other than the direction in which the anode and cathode lines are provided, and capturing a high-resolution and uniform electrophoresis image.

In the invention, it was found that, when MES (2-(N-Morpholino)ethanesulfuricacid) was used as the electrophoresis solution and a specimen for measuring red blood cells was dipped into the MES, a sulfonic acid group contained in the MES was tonically bonded to the amino group bonded to the red blood cell membrane with a sialic acid interposed therebetween, and the ionic bond therebetween caused the overall membrane potential of the specimen for measuring red blood cells to vary to a positive or negative level.

The findings proved that, when MES is used as the electrophoresis solution, a specimen for measuring red blood cells of a patient having a normal A1c value tended to have a positive polarity and be attracted to the cathode and a specimen for measuring red blood cells of a patient having an abnormal A1c value tended to have a negative polarity and be attracted to the anode. Therefore, another object of the invention is to provide an electrophoresis solution suitable for measuring the membrane potential of red blood cells using electrophoretic analysis.

According to an aspect of the invention, there is provided a method of measuring the membrane potential of red blood cells using electrophoresis analysis. The method includes: dipping an electrophoresis cell into an electrophoresis tank that contains an electrophoresis solution such that a current can flow at the middle of the electrophoresis tank; introducing a specimen for measuring red blood cells to a zero point at the center of the electrophoresis cell; capturing the image of the electrophoresis tank before a voltage is applied and at a predetermined time after the voltage is applied; performing RGB (red, green, and blue) analysis on image data of each of the captured images; measuring the moving coordinates of the brightness of each B (blue) component for each pixel using image analysis software, with the zero point used as a base point, thereby analyzing the images; and predicting the possibility of the specimen for measuring red blood cells being agglutinated in blood vessels on the basis of a variation in the electrophoresis direction indicated by the accumulation result of the moving coordinates of the analysis data toward an anode and a cathode.

According to another aspect of the invention, there is provided a method of measuring the membrane potential of red blood cells using electrophoresis analysis. The method includes: dipping an electrophoresis cell into an electrophoresis tank that contains an electrophoresis solution such that a current can flow at the middle of the electrophoresis tank; introducing a specimen for measuring red blood cells to a zero point at the center of the electrophoresis cell; capturing the image of the electrophoresis tank before a voltage is applied and at a predetermined time after the voltage is applied; performing RGB (red, green, and blue) analysis on image data of each of the captured images; measuring a vertex coordinate of the brightness of each B (blue) component for each pixel using image analysis software, with the zero point used as a base point, thereby analyzing the images; and measuring the viscosity of the specimen for measuring red blood cells on the basis of a variation in the vertex indicated by the accumulation result of the vertex coordinate of the analysis data.

According to still another aspect of the invention, there is provided a method of measuring the membrane potential of red blood cells using electrophoresis analysis. The method includes: dipping an electrophoresis cell into an electrophoresis tank that contains an electrophoresis solution such that a current can flow at the middle of the electrophoresis tank; introducing a specimen for measuring red blood cells to a zero point at the center of the electrophoresis cell; capturing the image of the electrophoresis tank before a voltage is applied and at a predetermined time after the voltage is applied; performing RGB (red, green, and blue) analysis on image data of each of the captured images; measuring the moving coordinates and/or the vertex coordinate of the brightness of each B (blue) component for each pixel using image analysis software, with the zero point used as a base point, thereby analyzing the images; and predicting the possibility of the specimen for measuring red blood cells being agglutinated in blood vessels and/or measuring the viscosity of the specimen for measuring red blood cells to predict the possibility of the specimen for measuring red blood cells being agglutinated in the blood vessels, on the basis of a variation in the electrophoresis direction indicated by the accumulation result of the moving coordinates of the analysis data toward an anode and a cathode and/or a variation in the vertex indicated by the accumulation result of the vertex coordinate of the analysis data.

In the method of measuring the membrane potential of red blood cells using electrophoresis analysis according to the above-mentioned aspects, preferably, in the analysis of the images, the RGB (red, green, and blue) analysis is performed on the image data that is obtained by capturing the image of the electrophoresis tank at least five times, that is, before the voltage is applied (0 minute) and 30 seconds, 1 minutes, 2 minutes, and 3 minutes after the voltage is applied. Preferably, the moving coordinates and/or the vertex coordinate of the brightness of each B (blue) component are measured for each pixel by the image analysis software using the zero point as the base point, and the measured data is analyzed by measurement software.

According to yet another aspect of the invention, there is provided an apparatus for measuring the membrane potential of red blood cells using electrophoresis analysis. The apparatus includes: an electrophoresis device that includes an electrophoresis tank having a central tank for dipping an electrophoresis cell and two tanks for inserting electrodes which are provided at both sides of the central tank, an electrophoresis solution poured into the electrophoresis cell, a pair of anode and cathode which are inserted into the tanks for inserting electrodes and connected to a DC power supply to supply a voltage, and the electrophoresis cell which is dipped into the tank for dipping an electrophoresis cell and has a specimen for measuring red blood cells introduced to the center thereof; an image capturing device that captures the image of the electrophoresis cell of the electrophoresis device before a voltage is applied and at a predetermined time after the voltage is applied; and an analyzing device that performs RGB (red, green, and blue) analysis on image data of each of the images captured by the image capturing device and measures the moving coordinates and/or the vertex coordinate of the brightness of each B (blue) component for each pixel using image analysis software, with the zero point used as a base point, thereby analyzing the images. In the electrophoresis device, partition walls, each having an electrophoresis solution passage hole formed at a lower part thereof, are provided among the three tanks provided in the electrophoresis tank such that the electrophoresis solution passes among the three tanks.

In the apparatus for measuring the membrane potential of red blood cells using electrophoretic analysis according to the above-mentioned aspect, preferably, the electrophoresis solution injected into the electrophoresis device is 2-(N-Morpholino)ethanesulfuricacid (MES; 0.05 mol/L, and pH 7.0). In the electrophoresis solution, a sulfonic acid group contained in the MES is tonically bonded to the amino group of the red blood cell membrane, and the ionic bond therebetween causes the overall membrane potential of the specimen for measuring red blood cells to vary to a positive or negative level.

In the apparatus for measuring the membrane potential of red blood cells using electrophoretic analysis according to the above-mentioned aspect, preferably, the electrophoresis cell dipped into the electrophoresis device is made of glass and formed in a half cylinder shape.

In the apparatus for measuring the membrane potential of red blood cells using electrophoretic analysis according to the above-mentioned aspect, preferably, the electrophoresis cell dipped into the electrophoresis device is formed by introducing ODS (coated with octadecylsilane) and binding albumin (for example, bovine serum albumin) to a concave inner surface using a physical absorption method (BSA coating).

In addition, a blood specimen (containing sodium nitride) for measuring glycohemoglobin (HbA1c) is used as the specimen for measuring red blood cells. The whole blood of 0.5 uL is introduced to the center of the electrophoresis cell, and analyzed by free flow electrophoresis. Then, the free flow electrophoresis is analyzed to examine a variation in the membrane potential of red blood cells.

In the method and apparatus for measuring the membrane potential of red blood cells using electrophoretic analysis according to the above-mentioned aspects, particularly, it is possible to predict the degree of disorder of the specimen for measuring red blood cells introduced into the electrophoresis cell by capturing the image of the electrophoresis tank before a voltage is applied and at a predetermined time after the voltage is applied, analyzing image data obtained from the captured image, digitizing the moving coordinates of the analysis data toward the cathode and the anode or/and the vertex coordinate of the analysis data to make a graph, and examining the distribution of the accumulation results.

As described above, according to the invention, an aspect provides a method of measuring the membrane potential of red blood cells using electrophoresis analysis that includes: dipping an electrophoresis cell into an electrophoresis tank that contains an electrophoresis solution such that a current can flow at the middle of the electrophoresis tank; introducing a specimen for measuring red blood cells to a zero point at the center of the electrophoresis cell; capturing the image of the electrophoresis tank before a voltage is applied and at a predetermined time after the voltage is applied; performing RGB (red, green, and blue) analysis on image data of each of the captured images; measuring the moving coordinates of the brightness of each B (blue) component for each pixel using image analysis software, with the zero point used as a base point, thereby analyzing the images; and predicting the possibility of the specimen for measuring red blood cells being agglutinated in blood vessels on the basis of a variation in the electrophoresis direction indicated by the accumulation result of the moving coordinates of the analysis data toward an anode and a cathode. According to the above-mentioned aspect, it is possible to discriminate normal red blood cells having a negative potential at their membranes and red blood cells which are likely to be agglutinated in blood vessels since their electrophoresis directions are reversed. As a result, it is possible to perform an appropriate medical treatment to prevent this kind of vascular disorders.

Further, another aspect of the invention provides a method of measuring the membrane potential of red blood cells using electrophoresis analysis that includes: dipping an electrophoresis cell into an electrophoresis tank that contains an electrophoresis solution such that a current can flow at the middle of the electrophoresis tank; introducing a specimen for measuring red blood cells to a zero point at the center of the electrophoresis cell; capturing the image of the electrophoresis tank before a voltage is applied and at a predetermined time after the voltage is applied; performing RGB (red, green, and blue) analysis on image data of each of the captured images; measuring a vertex coordinate of the brightness of each B (blue) component for each pixel using image analysis software, with the zero point used as a base point, thereby analyzing the images; and measuring the viscosity of the specimen for measuring red blood cells on the basis of a variation in the vertex indicated by the accumulation result of the vertex coordinate of the analysis data. According to the above-mentioned aspect, it is possible to prevent the occurrence of vascular disorders, such as thrombus, according to the measured result.

Furthermore, still another aspect of the invention provides a method of measuring the membrane potential of red blood cells using electrophoresis analysis that includes: dipping an electrophoresis cell into an electrophoresis tank that contains an electrophoresis solution such that a current can flow at the middle of the electrophoresis tank; introducing a specimen for measuring red blood cells to a zero point at the center of the electrophoresis cell; capturing the image of the electrophoresis tank before a voltage is applied and at a predetermined time after the voltage is applied; performing RGB (red, green, and blue) analysis on image data of each of the captured images; measuring the moving coordinates and/or the vertex coordinate of the brightness of each B (blue) component for each pixel using image analysis software, with the zero point used as a base point, thereby analyzing the images; and predicting the possibility of the specimen for measuring red blood cells being agglutinated in blood vessels and/or measuring the viscosity of the specimen for measuring red blood cells to predict the possibility of the specimen for measuring red blood cells being agglutinated in the blood vessels, on the basis of a variation in the electrophoresis direction indicated by the accumulation result of the moving coordinates of the analysis data toward an anode and a cathode and/or a variation in the vertex indicated by the accumulation result of the vertex coordinate of the analysis data. According to the above-mentioned aspect, it is possible to obtain a plurality of different kinds of measurement results using only one test measurement. As a result, it is possible to rapidly perform measurement for vascular disorders.

Further, in the method of measuring the membrane potential of red blood cells using electrophoresis analysis according to the above-mentioned aspects, in the analysis of the images, the RGB (red, green, and blue) analysis is performed on the image data that is obtained by capturing the image of the electrophoresis tank at least five times, that is, before the voltage is applied (0 minute) and 30 seconds, 1 minutes, 2 minutes, and 3 minutes after the voltage is applied. The moving coordinates and/or the vertex coordinate of the brightness of each B (blue) component are measured for each pixel by the image analysis software using the zero point as the base point, and the measured data is analyzed by measurement software. Therefore, it is possible to consistently perform comparison between specimens under the same conditions, and thus accurately examine the state of the specimens.

Furthermore, the method of measuring the membrane potential of red blood cells using electrophoretic analysis according to the above-mentioned aspects can help predict complications caused by vascular disorders and develop medicines for preventing the agglutination of blood cells in the near future, and can be helpful to define the proper usage of the medicine.

Furthermore, the method of measuring the membrane potential of red blood cells using electrophoretic analysis according to the above-mentioned aspects can measure the viscosity of blood cells. Therefore, the method can be helpful to develop an anticoagulant in the near future and to define the proper usage of the anticoagulant.

In addition, yet another aspect of the invention provides an apparatus for measuring the membrane potential of red blood cells using electrophoresis analysis that includes: an electrophoresis device that includes an electrophoresis tank having a central tank for dipping an electrophoresis cell and two tanks for inserting electrodes which are provided at both sides of the central tank, an electrophoresis solution poured into the electrophoresis cell, a pair of anode and cathode which are inserted into the tanks for inserting electrodes and connected to a DC power supply to supply a voltage, and the electrophoresis cell which is dipped into the tank for dipping an electrophoresis cell and has a specimen for measuring red blood cells introduced to the center thereof; an image capturing device that captures the image of the electrophoresis cell of the electrophoresis device before a voltage is applied and at a predetermined time after the voltage is applied; and an analyzing device that performs RGB (red, green, and blue) analysis on image data of each of the images captured by the image capturing device and measures the moving coordinates and/or the vertex coordinate of the brightness of each B (blue) component for each pixel using image analysis software, with the zero point used as a base point, thereby analyzing the images. In the electrophoresis device, partition walls, each having an electrophoresis solution passage hole formed at a lower part thereof, are provided among the three tanks provided in the electrophoresis tank such that the electrophoresis solution passes among the three tanks. According to the above-mentioned aspect, it is possible to prevent electrolytic bubbles generated from the cathode and the anode from being moved to the tank for dipping an electrophoresis cell. As a result, it is possible to capture a high-resolution and uniform electrophoresis image.

In the apparatus for measuring the membrane potential of red blood cells using electrophoretic analysis according to the above-mentioned aspect, the electrophoresis solution injected into the electrophoresis device is 2-(N-Morpholino)ethanesulfuricacid (MES; 0.05 mol/L, and pH 7.0). Therefore, the electrophoresis solution is most suitable for the electrophoresis of the specimen for measuring red blood cells.

In the apparatus for measuring the membrane potential of red blood cells using electrophoretic analysis according to the above-mentioned aspect, the electrophoresis cell dipped into the electrophoresis device is made of glass and formed in a half cylinder shape. Therefore, it is possible to prevent the specimens from being distributed in directions other than the direction in which the cathode and the anode are provided in electrophoresis distribution analysis.

In the apparatus for measuring the membrane potential of red blood cells using electrophoretic analysis according to the above-mentioned aspect, the electrophoresis cell dipped into the electrophoresis device has a concave inner surface coated with albumin. Therefore, it is possible to prevent adhesion between the inner surface and the specimen for measuring red blood cells, and thus implement consistent electrophoresis at all times.

In addition, a blood specimen (containing sodium nitride) for measuring glycohemoglobin (HbA1c) is used as the specimen for measuring red blood cells. The whole blood of 0.5 uL is introduced to the center of the electrophoresis cell, and analyzed by free flow electrophoresis. Then, the free flow electrophoresis is analyzed to examine a variation in the membrane potential of red blood cells. Therefore, it is possible to easily construct an apparatus for measuring the membrane potential of red blood cells using electrophoretic analysis.

### BRIEF DESCRIPTION OF THE DRAWINGS

FIG. 1 is a perspective view illustrating an apparatus for measuring the membrane potential of red blood cells using electrophoretic analysis according to an embodiment of the invention;

FIG. 2 is a cross-sectional view illustrating an electrophoresis cell provided in the apparatus for measuring the membrane potential of red blood cells using electrophoretic analysis according to the embodiment of the invention;

FIG. 3 is a cross-sectional view illustrating the apparatus for measuring the membrane potential of red blood cells using electrophoretic analysis according to the embodiment of the invention;

FIG. 4 is a diagram schematically illustrating the apparatus for measuring the membrane potential of red blood cells using electrophoretic analysis according to the embodiment of the invention;

FIG. 5 is an analysis graph illustrating the migration of a specimen for measuring red blood cells to an anode and a cathode and an A1c value when MES is used as an electrophoresis solution according to the embodiment of invention;

FIGS. 6A and 6B are a table and a graph illustrating numerical values indicating the moving coordinates of the specimens measured by a method of measuring the membrane potential of red blood cells using electrophoretic analysis according to an embodiment of the invention, respectively;

FIGS. 7A and 7B are a table and a graph illustrating numerical values indicating the moving coordinates of the specimens measured by the method of measuring the membrane potential of red blood cells using electrophoretic analysis according to the embodiment of the invention, respectively;

FIGS. 8A and 8B are a table and a graph illustrating numerical values indicating the moving coordinates of the specimens measured by the method of measuring the membrane potential of red blood cells using electrophoretic analysis according to the embodiment of the invention, respectively;

FIGS. 9A and 9B are a table and a graph illustrating numerical values indicating the moving coordinates of the specimens measured by the method of measuring the membrane potential of red blood cells using electrophoretic analysis according to the embodiment of the invention, respectively;

FIGS. 10A and 10B are a table and a graph illustrating numerical values indicating the moving coordinates of the specimens measured by the method of measuring the membrane potential of red blood cells using electrophoretic analysis according to the embodiment of the invention, respectively;

FIGS. 11A and 11B are a table and a graph illustrating numerical values indicating the moving coordinates of the specimens measured by the method of measuring the membrane potential of red blood cells using electrophoretic analysis according to the embodiment of the invention, respectively;

FIGS. 12A and 12B are a table and a graph illustrating numerical values indicating the vertex coordinates of the specimens measured by the method of measuring the membrane potential of red blood cells using electrophoretic analysis according to the embodiment of the invention, respectively;

FIGS. 13A and 13B are a table and a graph illustrating numerical values indicating the vertex coordinates of the specimens measured by the method of measuring the membrane potential of red blood cells using electrophoretic analysis according to the embodiment of the invention, respectively;

FIGS. 14A and 14B are a table and a graph illustrating numerical values indicating the vertex coordinates of the specimens measured by the method of measuring the membrane potential of red blood cells using electrophoretic analysis according to the embodiment of the invention, respectively;

FIGS. 15A and 15B are a table and a graph illustrating numerical values indicating the vertex coordinates of the specimens measured by the method of measuring the membrane potential of red blood cells using electrophoretic analysis according to the embodiment of the invention, respectively;

FIGS. 16A and 16B are a table and a graph illustrating numerical values indicating the vertex coordinates of the specimens measured by the method of measuring the membrane potential of red blood cells using electrophoretic analysis according to the embodiment of the invention, respectively;

FIGS. 17A and 17B are a table and a graph illustrating numerical values indicating the vertex coordinates of the specimens measured by the method of measuring the membrane potential of red blood cells using electrophoretic analysis according to the embodiment of the invention, respectively;

FIG. 18 is an analysis graph illustrating a variation in the moving coordinates and the vertex coordinate of the specimen measured by the method of measuring the membrane potential of red blood cells using electrophoretic analysis according to the embodiment of the invention with time; and

FIG. 19 is a reference diagram illustrating the related art.

### DESCRIPTION OF THE PREFERRED EMBODIMENTS

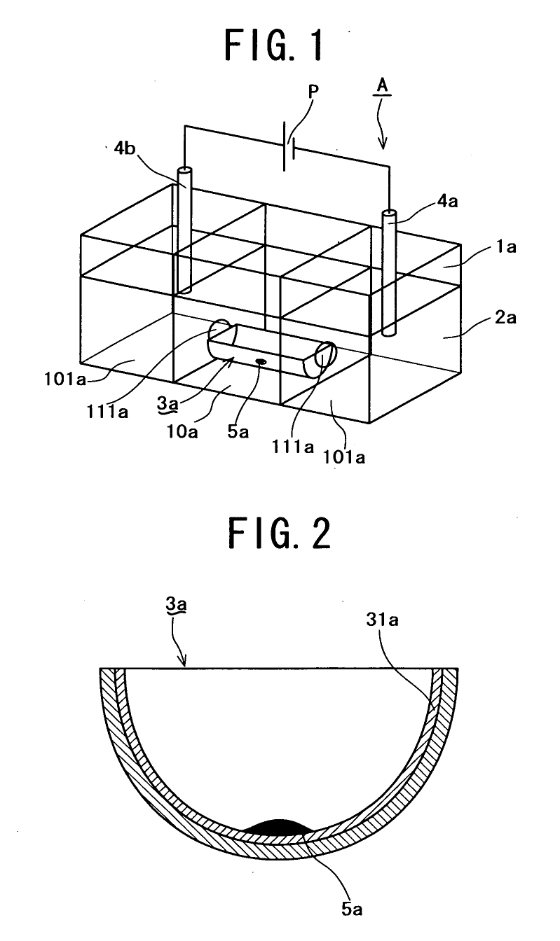

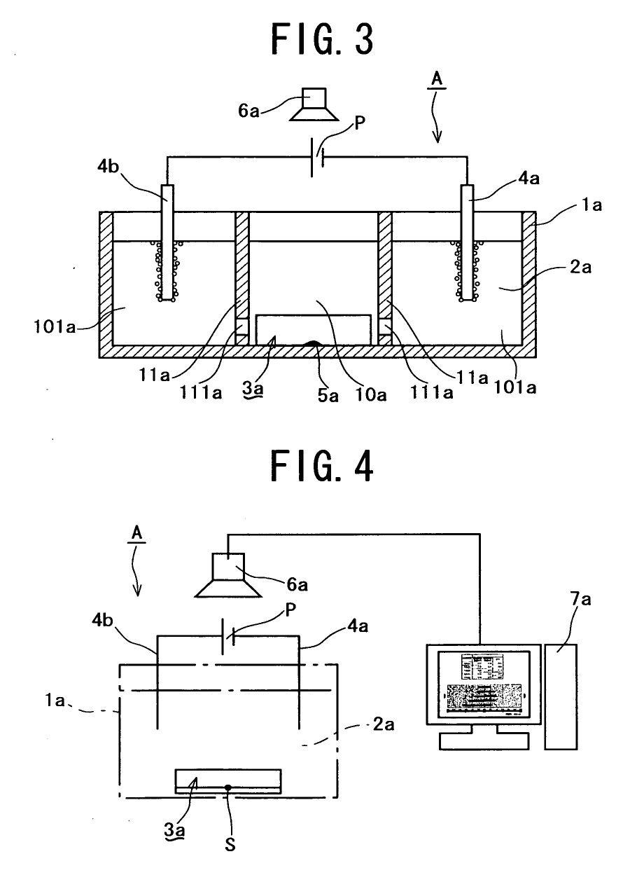

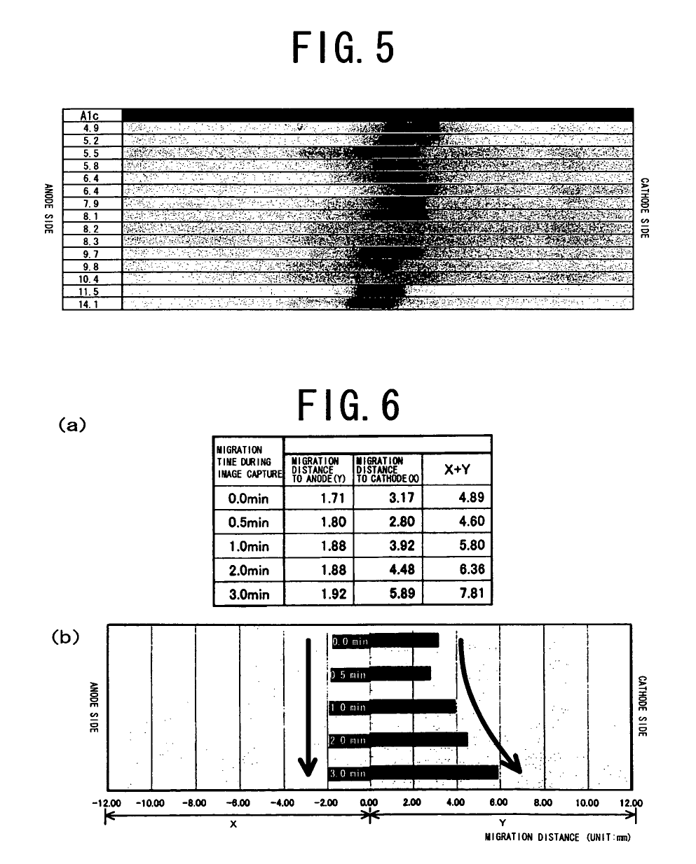

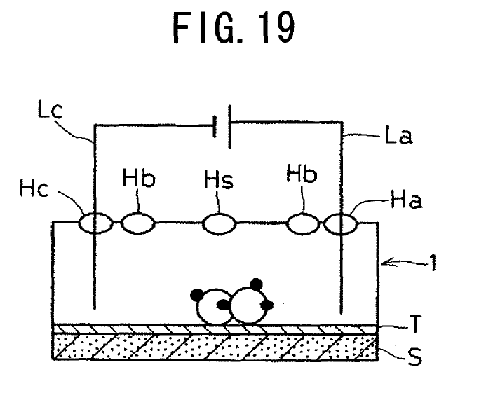

Hereinafter, a method and apparatus for measuring the membrane potential of red blood cells using electrophoretic analysis according to an embodiment of the invention will be described in detail with reference to the accompanying drawings. FIG. 1 is a perspective view illustrating an apparatus for measuring the membrane potential of red blood cells using electrophoretic analysis according to an embodiment of the invention. FIG. 2 is a cross-sectional view illustrating an electrophoresis cell provided in the apparatus for measuring the membrane potential of red blood cells using electrophoretic analysis according to the embodiment of the invention. FIG. 3 is a cross-sectional view illustrating the apparatus for measuring the membrane potential of red blood cells using electrophoretic analysis according to the embodiment of the invention. FIG. 4 is a diagram schematically illustrating the apparatus for measuring the membrane potential of red blood cells using electrophoretic analysis according to the embodiment of the invention. FIG. 5 is an analysis graph illustrating the migration of a specimen for measuring red blood cells to an anode and a cathode and an A1c value when MES is used as an electrophoresis solution according to the embodiment of invention. FIGS. 6A, 7A, 8A, 9A, 10A, and 11A are tables illustrating the measurement results of the migration distances Y and X of the specimen to the anode and the cathode corresponding to each electrophoresis time when the image of an electrophoresis tank is captured and the sum (X+Y) of the migration distances Y and X. FIGS. 6B, 7B, 8B, 9B, 10B, and 11B are analysis graphs made on the basis of the tables shown in FIGS. 6A, 7A, 8A, 9A, 10A, and 11A, respectively. FIGS. 12A, 13A, 14A, 15A, 16A, and 17A are tables illustrating the measurement result of the migration distance Z of the specimen in the height direction, which corresponds to each electrophoresis time when the image of the electrophoresis tank is captured, and the migration distance (X−Y) of the specimen on a line linking the anode and the cathode. FIGS. 12B, 13B, 14B, 15B, 16B, and 17B are analysis graphs made on the basis of the tables shown in FIGS. 12A, 13A, 14A, 15A, 16A, and 17A, respectively. FIG. 18 is an analysis graph illustrating a variation in the moving coordinates and the vertex coordinate of the specimens, which are measured by a method of measuring the membrane potential of red blood cells using electrophoretic analysis according to an embodiment of the invention, with time. FIG. 19 is a reference diagram illustrating the related art.

That is, in the method of measuring the membrane potential of red blood cells using electrophoretic analysis according to the embodiment of the invention, an electrophoresis cell is dipped into the electrophoresis tank that contains an electrophoresis solution such that a current can flow, and a specimen for measuring red blood cells is introduced to a zero point at the center of the electrophoresis cell. Then, the image of the electrophoresis tank is captured before a voltage is applied and at a predetermined time after the voltage is applied. Then, RGB (red, green, and blue) analysis is performed on image data of each of the captured images, and the moving coordinates of the brightness of each B (blue) component are measured for each pixel by image analysis software using the zero point as a base point, thereby analyzing the images. A variation in the electrophoresis direction indicated by the accumulation result of the moving coordinates of the analysis data to the anode and the cathode is observed. In this way, it is possible to predict the possibility of the specimen for measuring red blood cells being agglutinated in blood vessels.

For the moving coordinates of the analysis data with time, which is analyzed by the image analysis software, to the cathode and the anode, as shown in FIGS. 6A to 11B, the migration distance of the specimen for measuring red blood cells from the zero point to which the specimen is introduced to the anode is an X value, the migration distance of the specimen for measuring red blood cells from the zero point to the cathode is a Y value, and the accumulation result of the specimen at the coordinates is digitized as shown in FIGS. 6A, 7A, 8A, 9A, 10A and 11A. Then, the graphs shown in FIGS. 6B, 7B, 8B, 9B, 10B and 11B are made on the basis of the values, which are used to calculate the variation in the electrophoresis direction of the specimen for measuring red blood cells.

In the image analysis, RGB (red, green, and blue) analysis is performed on image data that is obtained by capturing the image of the electrophoresis tank at least five times, that is, before a voltage is applied (0 minute) and 30 seconds, 1 minutes, 2 minutes, and 3 minutes after the voltage is applied, and the moving coordinates and/or the vertex coordinates of the brightness of each B (blue) component are measured for each pixel by image analysis software using the zero point as a base point. The measured data is analyzed by measurement software.

In this embodiment, MES (2(N-Morpholino)ethanesulfuricacid) is used as the electrophoresis solution. The inventor found that, when the specimen for measuring red blood cells was dipped into the MES, a sulfonic group contained in the MES was ionically bonded to the amino group of the red blood cell membrane, and the ionic bond therebetween caused the overall membrane potential of the specimen for measuring red blood cells to vary to a positive or negative level. The findings proved that the specimen in a patient having an A1c value in the normal range tended to be attracted to the cathode and the specimen in a patient having an A1c value in the abnormal range tended to be attracted to the anode.

That is, FIG. 5 is an analysis graph illustrating the migration of the specimen for measuring red blood cells to the anode and the cathode and an A1c value when MES is used as the electrophoresis solution. As can be seen from FIG. 5, it is remarkable that the specimen in the patient having an A1c value in the normal range tends to have a positive polarity and be attracted to the cathode and the specimen in the patient having an A1c value in the abnormal range tends to have a negative polarity and be attracted to the anode.

For example, FIGS. 6A and 6B show an example in which a 0.5 uL whole blood collected from the patient having a HbA1c value of 5.3 (normal value) is used. As can be seen from FIG. 6A, before a voltage is applied (0 minute) after the specimen for measuring red blood cells is introduced to the zero point, the Y value is 1.71 mm, and the X value is 3.17 mm (Y+X=4.88). The Y value is 1.80 mm, and the X value is 2.80 mm (Y+X=4.60) 30 seconds after the voltage is applied. The Y value is 1.88 mm, and the X value is 3.92 mm (Y+X=5.80) one minute after the voltage is applied. The Y value is 1.88 mm, and the X value is 4.48 mm (Y+X=6.36) two minutes after the voltage is applied. The Y values is 1.92 mm, and the X value is 5.89 mm (Y+X=7.81) 3 minutes after the voltage is applied.

FIG. 6B is a graph made on the basis of the values. The graph shows that the red blood cells in the specimen for measuring red blood cells are distributed close to the cathode with time, as represented by an arrow, but no red blood cell whose membrane potential is reversed is observed. Therefore, the patient having a normal HbA1c value can be diagnosed to have a low incidence of red blood cell agglutination.

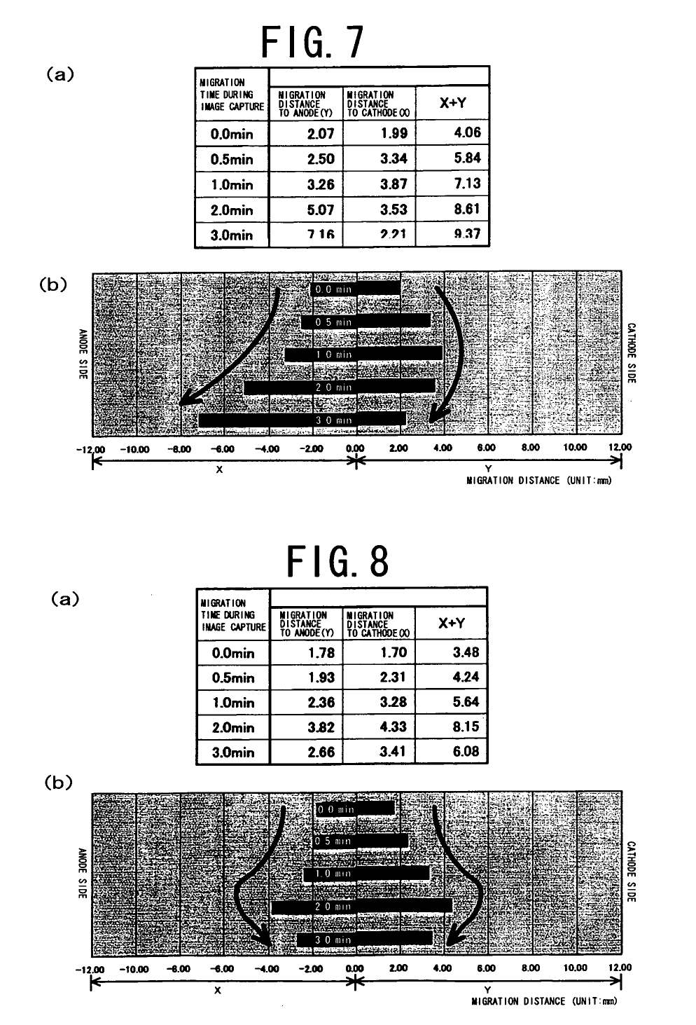

FIGS. 7A and 7B show an example in which a 0.5 uL whole blood collected from the patient having a HbA1c value of 5.0 (normal value) is used. As can be seen from FIG. 7A, before a voltage is applied (0 minute) after the specimen for measuring red blood cells is introduced to the zero point, the Y value is 2.07 mm, and the X value is 1.99 mm (Y+X=4.06). The Y value is 2.50 mm, and the X value is 3.34 mm (Y+X=5.84) 30 seconds after the voltage is applied. The Y value is 3.26 mm, and the X value is 3.87 mm (Y+X=7.13) one minute after the voltage is applied. The Y value is 5.07 mm, and the X value is 3.53 mm (Y+X=8.60) two minutes after the voltage is applied. The Y values is 7.16 mm, and the X value is 2.21 mm (Y+X=9.37) 3 minutes after the voltage is applied.

FIG. 7B is a graph made on the basis of the values. The graph shows that the red blood cells in the specimen for measuring red blood cells are distributed relatively close to the anode with time, as represented by an arrow, but no red blood cell whose membrane potential is reversed is observed. Therefore, it can be diagnosed that, even though having a normal HbA1c value, the patient has a high incidence of red blood cell agglutination.

FIGS. 8A and 8B show an example in which a 0.5 uL whole blood collected from the patient having a HbA1c value of 5.6 (approximately normal value) is used. As can be seen from FIG. 8A, before a voltage is applied (0 minute) after the specimen for measuring red blood cells is introduced to the zero point, the Y value is 1.78 mm, and the X value is 1.70 mm (Y+X=3.48). The Y value is 1.93 mm, and the X value is 2.31 mm (Y+X=4.24) 30 seconds after the voltage is applied. The Y value is 2.36 mm, and the X value is 3.28 mm (Y+X=5.64) one minute after the voltage is applied. The Y value is 3.82 mm, and the X value is 4.33 mm (Y+X=8.15) two minutes after the voltage is applied. The Y values is 2.66 mm, and the X value is 3.41 mm (Y+X=6.07) 3 minutes after the voltage is applied.

FIG. 8B is a graph made on the basis of the values. The graph shows that the red blood cells in the specimen for measuring red blood cells are distributed slightly close to the cathode for two minutes after the voltage is applied, and after two minutes, the electrophoresis direction is reversed. That is, it is supposed that factors causing red blood cell agglutination are included in the specimen for measuring red blood cells, which can be used as predictions for red blood cell agglutination.

As described above, this embodiment of the invention can predict red blood cell agglutination for patients having a normal HbA1c value or an approximate value thereof, which has not been performed in electrophoresis.

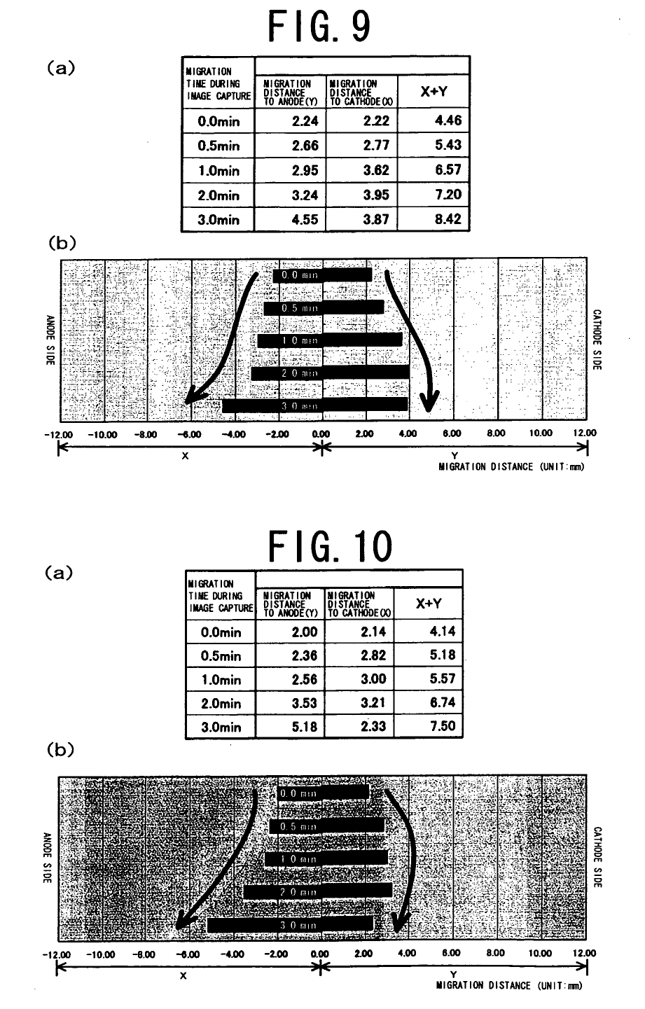

FIGS. 9A and 9B show an example in which a 0.5 uL whole blood collected from the patient having a HbA1c value of 8.0 (abnormal value) is used. As can be seen from FIG. 9A, before a voltage is applied (0 minute) after the specimen for measuring red blood cells is introduced to the zero point, the Y value is 2.24 mm, and the X value is 2.22 mm (Y+X=4.46). The Y value is 3.66 mm, and the X value is 2.77 mm (Y+X=5.43) 30 seconds after the voltage is applied. The Y value is 2.95 mm, and the X value is 3.62 mm (Y+X=6.57) one minute after the voltage is applied. The Y value is 3.24 mm, and the X value is 3.95 mm (Y+X=7.19) two minutes after the voltage is applied. The Y values is 4.55 mm, and the X value is 3.87 mm (Y+X=8.42) 3 minutes after the voltage is applied.

FIG. 9B is a graph made on the basis of the values. The graph shows that the red blood cells in the specimen for measuring red blood cells are distributed slightly close to the anode with time, as represented by an arrow, but no red blood cell whose membrane potential is reversed is observed. Therefore, it can be diagnosed that, even though having an abnormal HbA1c value, the patient has a relatively low incidence of red blood cell agglutination.

FIGS. 10A and 10B show an example in which a 0.5 uL whole blood collected from the patient having a HbA1c value of 8.1 (abnormal value) is used. As can be seen from FIG. 10A, before a voltage is applied (0 minute) after the specimen for measuring red blood cells is introduced to the zero point, the Y value is 2.00 mm, and the X value is 2.14 mm (Y+X=4.14). The Y value is 2.36 mm, and the X value is 2.82 mm (Y+X=5.18) 30 seconds after the voltage is applied. The Y value is 2.56 mm, and the X value is 3.00 mm (Y+X=5.56) one minute after the voltage is applied. The Y value is 3.53 mm, and the X value is 3.21 mm (Y+X=6.74) two minutes after the voltage is applied. The Y values is 5.18 mm, and the X value is 2.33 mm (Y+X=7.51) 3 minutes after the voltage is applied.

As can be seen from FIG. 10B showing the graph made on the basis of the values, the red blood cells included in the specimen are widely distributed close to the anode with time, as represented by an arrow. Therefore, it can be diagnosed that the patents having an abnormal HbA1c value need to pay attention to red blood cell agglutination.

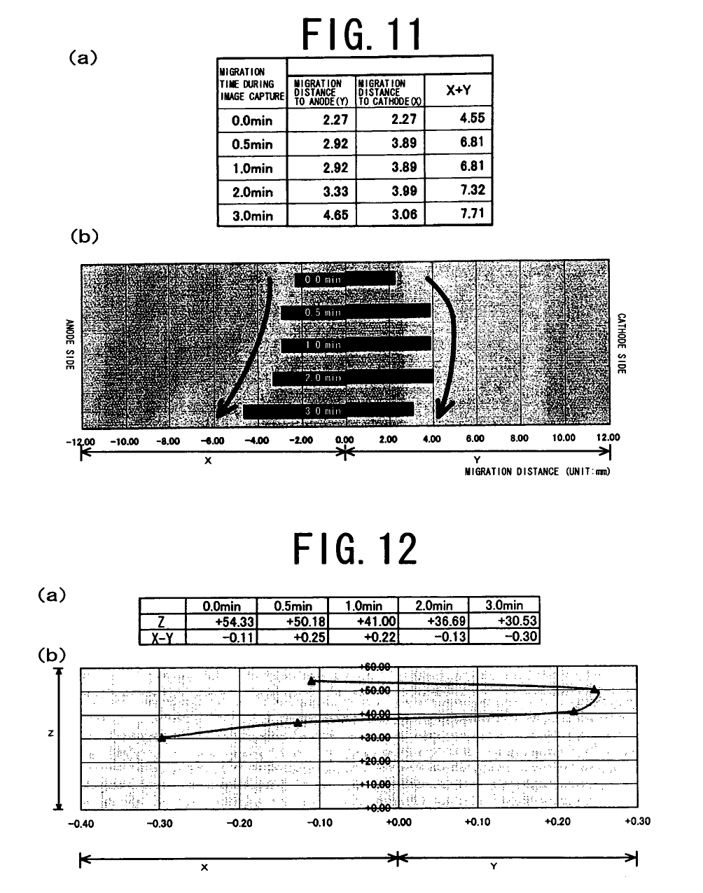

FIGS. 11A and 11B show an example in which a 0.5 uL whole blood collected from the patient having a HbA1c value of 8.9 (abnormal value) is used. As can be seen from FIG. 11A, before a voltage is applied (0 minute) after the specimen for measuring red blood cells is introduced to the zero point, the Y value is 2.27 mm, and the X value is 2.27 mm (Y+X=4.54). The Y value is 2.92 mm, and the X value is 3.89 mm (Y+X=6.81) 30 seconds after the voltage is applied. The Y value is 2.92 mm, and the X value is 3.89 mm (Y+X=6.81) one minute after the voltage is applied. The Y value is 3.33 mm, and the X value is 3.99 mm (Y+X=7.32) two minutes after the voltage is applied. The Y values is 4.65 mm, and the X value is 3.06 mm (Y+X=7.71) 3 minutes after the voltage is applied.

As can be seen from FIG. 11B showing the graph made on the basis of the values, the red blood cells included in the specimen are distributed close to the anode with time, as represented by an arrow. Therefore, it can be diagnosed that the patents having an abnormal HbA1c value need to pay attention to red blood cell agglutination.

As described above, the method according to this embodiment can predict red blood cell agglutination regardless of the HbA1c value.

In the method of measuring the membrane potential of red blood cells using electrophoretic analysis according to the embodiment of the invention, as described above, an electrophoresis cell is dipped into the electrophoresis tank that contains an electrophoresis solution such that a current can flow, and a specimen for measuring red blood cells is introduced to a zero point at the center of the electrophoresis cell. Then, the image of the electrophoresis tank is captured before a voltage is applied and at a predetermined time after the voltage is applied. Then, RGB (red, green, and blue) analysis is performed on image data of each of the captured images, and the vertex coordinate of the brightness of each B (blue) component is measured for each pixel by image analysis software using the zero point as a base point, thereby analyzing the images. A variation in the vertex indicated by the accumulation result of each of the vertex coordinates of the analysis data is observed. In this way, it is possible to measure the viscosity of the specimen for measuring red blood cells.

That is, as shown in FIGS. 12A to 17B, a variation in the migration of the specimen to the cathode and the anode in the vertex coordinates is represented by an X−Y value composed of an X value (negative value) indicating the migration distance of the specimen from the zero point, serving as a base point, to which the specimen for measuring red blood cells is introduced to the anode, and a Y value (positive value) indicating the migration distance of the specimen from the zero point to the cathode. In addition, the migration distance of the specimen from the zero point in the height direction is referred to as a Z value (positive value). The accumulation result at the vertex coordinate is digitized as shown in FIGS. 12A, 13A, 14A, 15A, 16A, and 17A, and the graphs shown in FIGS. 12B, 13B, 14B, 15B, 16B, and 17B are made on the basis of the values. In this way, it is possible to measure the viscosity of the specimen for measuring red blood cells.

The viscosity of the specimen for measuring red blood cell can be measured on the basis of, for example, a Z value change index at a predetermined time.

For example, FIGS. 12A and 12B show an example in which a 0.5 uL whole blood collected from the patient having a HbA1c value of 4.8 (normal value) is used. As can be seen from FIGS. 12A and 12B, before a voltage is applied (0 minute) after the specimen for measuring red blood cells is introduced to the zero point, the Z value is 54.33, and the (X−Y) value is −0.11 mm (Z is an index). The Z value is 50.18, and the (X−Y) value is 0.25 mm 30 seconds after the voltage is applied. The Z value is 41.00, and the (X−Y) value is 0.22 mm one minute after the voltage is applied. The Z value is 36.69, and the (X−Y) value is −0.13 mm two minutes after the voltage is applied. The Z value is 30.53, and the (X−Y) value is −0.30 mm 3 minutes after the voltage is applied.

Therefore, the maximum change index range of the Z value of the specimen for measuring red blood cells is 23.8 (=54.33−30.53).

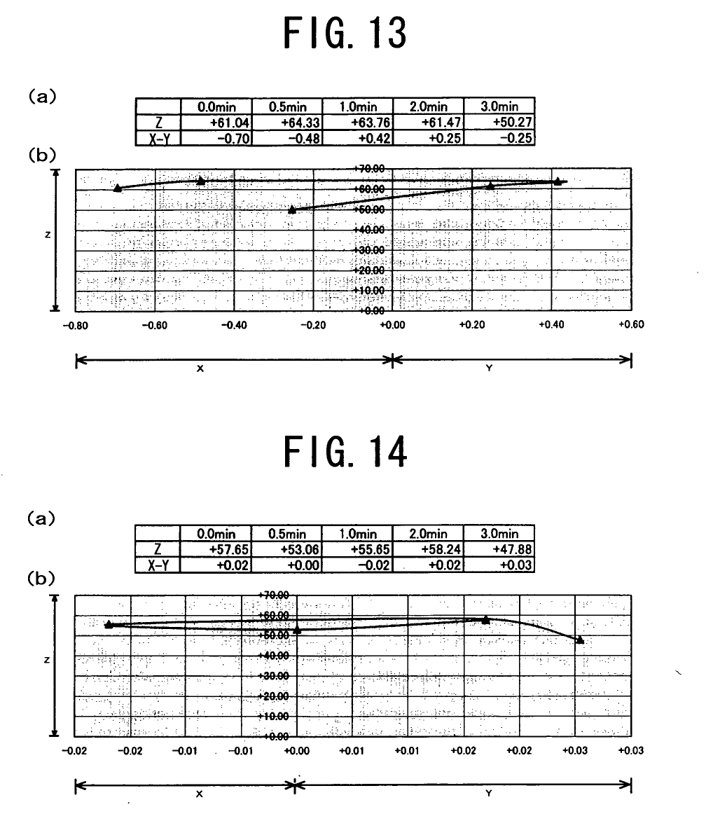

FIGS. 13A and 13B show an example in which a 0.5 uL whole blood collected from the patient having a HbA1c value of 5.0 (normal value) is used. As can be seen from FIGS. 13A and 13B, before a voltage is applied (0 minute) after the specimen for measuring red blood cells is introduced to the zero point, the Z value is 61.04, and the (X−Y) value is −0.70 mm. The Z value is 64.33, and the (X−Y) value is −0.48 mm 30 seconds after the voltage is applied. The Z value is 63.76, and the (X−Y) value is 0.42 mm one minute after the voltage is applied. The Z value is 61.47, and the (X−Y) value is 0.25 mm two minutes after the voltage is applied. The Z value is 50.27, and the (X−Y) value is −0.25 mm 3 minutes after the voltage is applied.

Therefore, the maximum change index range of the Z value of the specimen for measuring red blood cells is 14.06 (=64.33−50.27).

FIGS. 14A and 14B show an example in which a 0.5 uL whole blood collected from the patient having a HbA1c value of 5.6 (approximately normal value) is used. As can be seen from FIGS. 14A and 14B, before a voltage is applied (0 minute) after the specimen for measuring red blood cells is introduced to the zero point, the Z value is 57.65, and the (X−Y) value is 0.02 mm. The Z value is 53.06, and the (X−Y) value is 0.00 mm 30 seconds after the voltage is applied. The Z value is 55.65, and the (X−Y) value is −0.02 mm one minute after the voltage is applied. The Z value is 58.24, and the (X−Y) value is 0.02 mm two minutes after the voltage is applied. The Z value is 47.88, and the (X−Y) value is 0.03 mm 3 minutes after the voltage is applied.

Therefore, the maximum change index range of the Z value of the specimen for measuring red blood cells is 10.36 (=58.24−47.88).

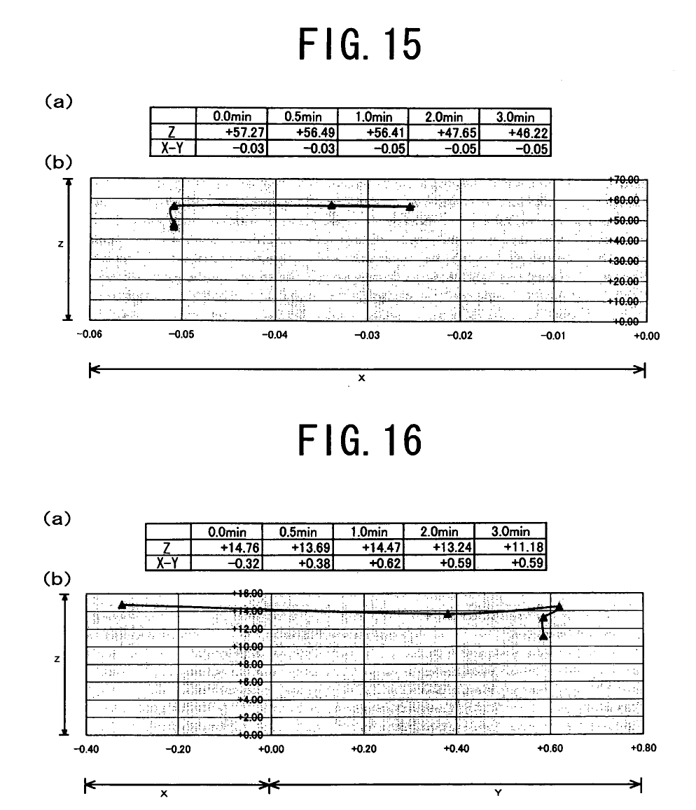

FIGS. 15A and 15B show an example in which a 0.5 uL whole blood collected from the patient having a HbA1c value of 8.0 (abnormal value) is used. As can be seen from FIGS. 15A and 15B, before a voltage is applied (0 minute) after the specimen for measuring red blood cells is introduced to the zero point, the Z value is 57.27, and the (X−Y) value is −0.03 mm. The Z value is 56.49, and the (X−Y) value is −0.03 mm 30 seconds after the voltage is applied. The Z value is 56.41, and the (X−Y) value is −0.05 mm one minute after the voltage is applied. The Z value is 47.65, and the (X−Y) value is −0.05 mm two minutes after the voltage is applied. The Z value is 46.22, and the (X−Y) value is −0.05 mm 3 minutes after the voltage is applied.

Therefore, the maximum change index range of the Z value of the specimen for measuring red blood cells is 11.05 (=57.27−46.22).

FIGS. 16A and 16B show an example in which a 0.5 uL whole blood collected from the patient having a HbA1c value of 8.1 (abnormal value) is used. As can be seen from FIGS. 16A and 16B, before a voltage is applied (0 minute) after the specimen for measuring red blood cells is introduced to the zero point, the Z value is 14.76, and the (X−Y) value is −0.32 mm. The Z value is 13.69, and the (X−Y) value is −0.38 mm 30 seconds after the voltage is applied. The Z value is 14.47, and the (X−Y) value is 0.62 mm one minute after the voltage is applied. The Z value is 13.24, and the (X−Y) value is 0.59 mm two minutes after the voltage is applied. The Z value is 11.18, and the (X−Y) value is 0.59 mm 3 minutes after the voltage is applied.

Therefore, the maximum change index range of the Z value of the specimen for measuring red blood cells is 3.58 (=14.76−11.18).

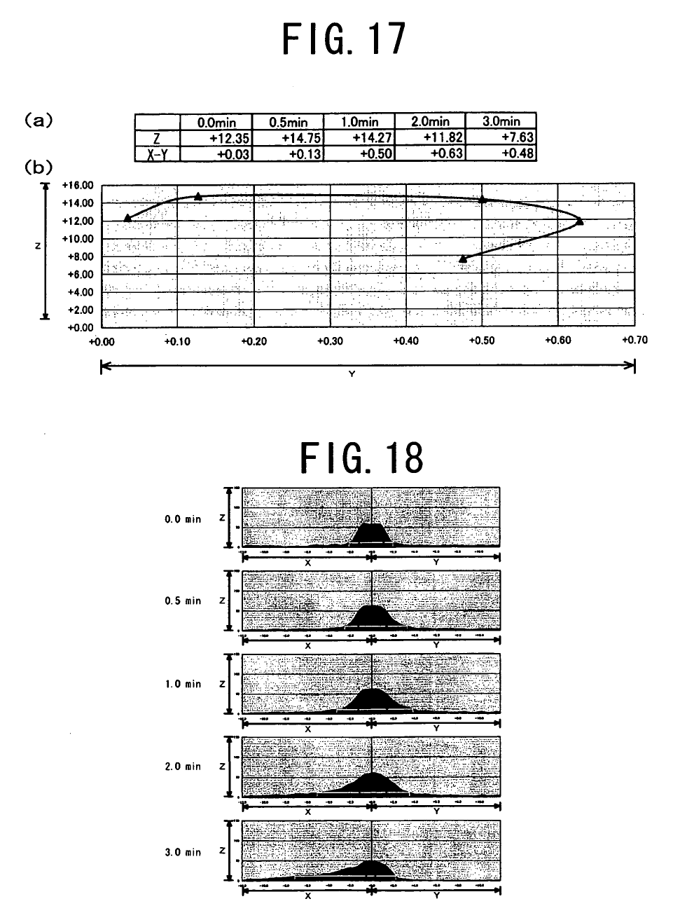

FIGS. 17A and 17B show an example in which a 0.5 uL whole blood collected from the patient having a HbA1c value of 8.9 (abnormal value) is used. As can be seen from FIGS. 17A and 17B, before a voltage is applied (0 minute) after the specimen for measuring red blood cells is introduced to the zero point, the Z value is 12.35, and the (X−Y) value is 0.03 mm. The Z value is 14.75, and the (X−Y) value is 0.13 mm 30 seconds after the voltage is applied. The Z value is 14.27, and the (X−Y) value is 0.50 mm one minute after the voltage is applied. The Z value is 11.82, and the (X−Y) value is 0.63 mm two minutes after the voltage is applied. The Z value is 7.63, and the (X−Y) value is 0.48 mm 3 minutes after the voltage is applied.

Therefore, the maximum change index range of the Z value of the specimen for measuring red blood cells is 7.12 (=14.75−7.63).

The comparison result between the maximum change index ranges of the Z values shown in FIG. 12A to 17B shows that there is a remarkable difference between the viscosities of the specimens for measuring red blood cells. That is, it is supposed that, as shown in FIGS. 12A and 12B and FIGS. 13A and 13B, the wider the index range becomes, the lower the viscosity of the specimen for measuring red blood cells becomes, and as shown in FIGS. 16A and 16B and FIGS. 17A and 17B, the narrower the index range becomes, the higher the viscosity of the specimen for measuring red blood cells becomes.

When the viscosity of the specimen for measuring red blood cells is measured from the accumulation result at the vertex coordinate, it is also possible to predict the possibility of red blood cell agglutination in the specimen by observing a variation in the electrophoresis direction on the basis of the accumulation result of each of the moving coordinates (X, Y) of the specimen for measuring red blood cells to the cathode and the anode.

In this case, as shown in FIG. 18, the variation in the electrophoresis direction with time may be observed on the basis of a graph image capable of simultaneously displaying the moving coordinates (X, Y) and the vertex coordinate (Z).

Next, the apparatus for measuring the membrane potential of red blood cells using electrophoretic analysis according to the embodiment of the invention will be described. FIGS. 1 and 4 show the measuring apparatus including an electrophoresis device A, an image capturing device 6a, and an analyzing device 7a.

That is, as shown in FIGS. 1 and 3, the electrophoresis device A includes a tank 10a (2.7 cm×2.5 cm×3 cm) for dipping an electrophoresis cell, which is provided at the center, and tanks 101a for inserting electrodes, which are provided at both sides of the tank 10a. In addition, partition walls 11a, each having an electrophoresis solution passage hole 111a formed at a lower part thereof, are provided among the tank 10a and the tanks 101a such that an electrophoresis solution 2a passes among the tanks 10a and 111a. The three tanks form an electrophoresis tank 1a. The electrophoresis tank 1a has the electrophoresis solution 2a poured thereinto, and a pair of a cathode 4a and an anode 4b that are connected to a DC power supply P to apply a voltage are inserted into the two tanks 101a for inserting electrodes. In addition, an electrophoresis cell 3a that introduces a specimen 5a for measuring red blood cells at the center thereof is dipped into the tank 10a for dipping an electrophoresis cell at the center thereof. When the membrane potential of red blood cells is measured, the specimen 5a for measuring red blood cells is introduced to the zero point (base point) at the center of the electrophoresis cell 3a by, for example, a pipette, and variation in the electrophoresis direction of the specimen is observed.

As described above, the apparatus for measuring the membrane potential of red blood cells according to the embodiment of the invention includes the image capturing device 6a that captures the image of the electrophoresis cell 3a in the electrophoresis device A before a voltage is applied and at a predetermined time after the voltage is applied; and the analyzing device 7a (for example, a personal computer) that performs RGB (red, green, and blue) analysis on each image data obtained by the image capturing device 6a and measures the moving coordinates or/and the vertex coordinate of the brightness of each B (blue) component for each pixel using image analysis software, with a zero point S used as a base point, thereby analyzing the images. The apparatus for measuring the membrane potential of red blood cells is configured as shown in FIG. 4.

In this embodiment, 2-(N-Morpholino)ethanesulfuricacid (MES; 0.05 mol/L and pH 7.0) is used as the electrophoresis solution 2a.

The electrophoresis tank 1a has a rectangular parallelepiped shape (8 cm×2.5 cm×3 cm) and is formed of polypropylene). However, the material forming the electrophoresis tank is not limited thereto. For example, the electrophoresis tank may be formed of other transparent resins or glass plates.

As shown in FIGS. 1 and 2, the electrophoresis cell 3a is dipped into the electrophoresis solution 2a at the center of the electrophoresis device A, and is formed in a glass half cylinder shape (inside diameter is 14 mm, depth is 7 mm, and length is 25 mm).

Further, as shown in FIG. 2, the inner surface of the concave electrophoresis cell 3a is coated with albumin (BSA coating) in order to prevent the specimen 5a for measuring red blood cells from being adhered to the inner surface.

In this embodiment, a digital camera on the market (COOLPIX995, NIKON) is used as the image capturing device 6a.

Further, in this embodiment, a blood specimen (containing sodium nitride) for measuring glycohemoglobin (HbA1c) is used as the specimen 5a for measuring red blood cells.

In the apparatus for measuring the membrane potential of red blood cells according to this embodiment of the invention, a 0.5 uL whole blood of the specimen 5a for measuring red blood cells is introduced to the center of the electrophoresis cell 3a of the electrophoresis device A, and is analyzed by free flow electrophoresis. Then, the free flow electrophoresis image is analyzed to examine the state of the membrane potential of red blood cells.

A contact voltage (100 V; 20 to 30 mA) is applied between the cathode 4a and the anode 4b at room temperature for three minutes, and an electrophoresis image is captured by image capturing device 6a. Then, the analyzing device 7a performs RGB analyze on the captured image (5 mega pixels), and the brightness of each B component is measured for each pixel by image analysis software (WinRoof, MITANI CORPORATION). Then, the data is analyzed by EXCEL (Microsoft).

As described above, the method and apparatus for measuring the membrane potential of red blood cells using electrophoretic analysis according to the embodiments of the invention is characterized in that: the image of the electrophoresis tank 1a including the electrophoresis cell 3a to which the specimen 5a for measuring red blood cells is introduced is captured before a voltage is applied and at a predetermined time after the voltage is applied; image data of each of the captured images is analyzed; the moving coordinates and/or the vertex coordinate of the analysis data with time toward the cathode 4a and the anode 4b are digitized; a graph is made on the basis of the values; and the degree of failure of the specimen for measuring red blood cells is predicted from the distribution of the accumulation results.

1. A method of measuring the membrane potential of red blood cells using electrophoresis analysis, the method comprising:
dipping an electrophoresis cell into an electrophoresis tank that contains an electrophoresis solution such that a current flows at the middle of the electrophoresis tank;
introducing a specimen for measuring red blood cells to a zero point at the center of the electrophoresis cell;
capturing the image of the electrophoresis tank before a voltage is applied and at a predetermined time after the voltage is applied;
performing RGB (red, green, and blue) analysis on image data of each of the captured images;
measuring the moving coordinates of the brightness of each B (blue) component for each pixel using image analysis software, with the zero point used as a base point, thereby analyzing the images; and
predicting the possibility of the specimen for measuring red blood cells being agglutinated in blood vessels on the basis of a variation in the electrophoresis direction indicated by the accumulation result of the moving coordinates of the analysis data toward an anode and a cathode.

2. A method of measuring the membrane potential of red blood cells using electrophoresis analysis, the method comprising:
dipping an electrophoresis cell into an electrophoresis tank that contains an electrophoresis solution such that a current flows at the middle of the electrophoresis tank;
introducing a specimen for measuring red blood cells to a zero point at the center of the electrophoresis cell;
capturing the image of the electrophoresis tank before a voltage is applied and at a predetermined time after the voltage is applied;
performing RGB (red, green, and blue) analysis on image data of each of the captured images;
measuring the moving coordinates and/or the vertex coordinate of the brightness of each B (blue) component for each pixel using image analysis software, with the zero point used as a base point, thereby analyzing the images; and
predicting the possibility of the specimen for measuring red blood cells being agglutinated in blood vessels and/or measuring the viscosity of the specimen for measuring red blood cells to predict the possibility of the specimen for measuring red blood cells being agglutinated in the blood vessels, on the basis of a variation in the electrophoresis direction indicated by the accumulation result of the moving coordinates of the analysis data toward an anode and a cathode and/or a variation in the vertex indicated by the accumulation result of the vertex coordinate of the analysis data.

3. The method of measuring the membrane potential of red blood cells using electrophoresis analysis according to claim 1,
wherein, in the analysis of the images, the RGB (red, green, and blue) analysis is performed on the image data that is obtained by capturing the image of the electrophoresis tank at least five times, that is, before the voltage is applied (0 minute) and 30 seconds, 1 minutes, 2 minutes, and 3 minutes after the voltage is applied,
the moving coordinates and/or the vertex coordinate of the brightness of each B (blue) component are measured for each pixel by the image analysis software using the zero point as the base point, and
the measured data is analyzed by measurement software.

4. An apparatus for measuring the membrane potential of red blood cells using electrophoresis analysis, the apparatus comprising:
an electrophoresis device that includes an electrophoresis tank having a central tank for dipping an electrophoresis cell and two tanks for inserting electrodes which are provided at both sides of the central tank, an electrophoresis solution poured into the electrophoresis cell, a pair of anode and cathode which are inserted into the tanks for inserting electrodes and connected to a DC power supply to supply a voltage, and the electrophoresis cell which is dipped into the tank for dipping an electrophoresis cell and has a specimen for measuring red blood cells introduced to the center thereof;
an image capturing device that captures the image of the electrophoresis cell of the electrophoresis device before a voltage is applied and at a predetermined time after the voltage is applied; and
an analyzing device that performs RGB (red, green, and blue) analysis on image data of each of the images captured by the image capturing device and measures the moving coordinates and/or the vertex coordinate of the brightness of each B (blue) component for each pixel using image analysis software, with the zero point used as a base point, thereby analyzing the images,
wherein partition walls, each having an electrophoresis solution passage hole formed at a lower part thereof, are provided among the three tanks provided in the electrophoresis tank such that the electrophoresis solution passes among the three tanks.

5. The apparatus for measuring the membrane potential of red blood cells using electrophoretic analysis according to claim 4,
wherein the electrophoresis solution of the electrophoresis device consists of 2-(N-Morpholino)ethanesulfuricacid (MES; 0.05 mol/L, and pH 7.0).

6. The apparatus for measuring the membrane potential of red blood cells using electrophoretic analysis according to claim 4,
wherein the electrophoresis cell of the electrophoresis device is made of glass and formed in a half cylinder shape.

7. The apparatus for measuring the membrane potential of red blood cells using electrophoretic analysis according to claim 4,
wherein the electrophoresis cell of the electrophoresis device has a concave inner surface coated with albumin.
